(19) United States
(12) Patent Application Publication
(10) Pub. No.: US 2026/0257466 A1
(43) Pub. Date: Sep. 3, 2026

(54) LAMINATING SYSTEM AND RECORDING MEDIUM

(71) Applicant: Konica Minolta, Inc., Tokyo (JP)

(72) Inventor: Kenichi Yamada, Tokyo (JP)

(73) Assignee: Konica Minolta, Inc., Tokyo (JP)

(21) Appl. No.: 19/382,976

(22) Filed: Nov. 7, 2025

(30) Foreign Application Priority Data
Nov. 8, 2024 (JP) 2024-195884

(51) Int. Cl. B32B 41/00

(52) U.S. Cl. CPC B32B 41/00; B32B 2309/72

(57) ABSTRACT

A laminating system includes: a lamination processor that performs a lamination process on a sheet by using a laminate film; and a hardware processor that: calculates a remaining amount of the laminate film based on a feed amount of the laminate film; and, when the remaining amount of the laminate film is equal to or less than a predetermined threshold value, determines that the laminate film is in a near-empty state and stops the lamination processor. In response to a trouble occurring in the laminating system, the hardware processor updates the remaining amount of the laminate film by subtracting a predetermined amount from the remaining amount of the laminate film.

### CROSS-REFERENCE TO RELATED APPLICATIONS

The entire disclosure of Japanese Patent Application No. 2024-195884 filed on Nov. 8, 2024, is incorporated herein by reference in its entirety.

### BACKGROUND OF THE INVENTION

### Technical Field

The present disclosure relates to a laminating system and a recording medium.

### Description of Related Art

In a laminating device that performs a lamination process by bonding a laminate film (film) onto a sheet, the following problem arises when the film that is in the form of a roll reaches the end of the roll during the lamination process. Specifically, a sudden stop of the film conveyance causes the conveyance of the stopped film and the conveyance of the sheet to become misaligned with each other, thus causing great damage to the drive mechanisms of the film and the sheet. A failure in the lamination process occurs due to the sudden stop of the film conveyance.

In order to solve the above-mentioned problem, in the invention described in JP H05-229000A, it is described that when the remaining amount of the film is detected to be small (near-empty state), the conveyance of the film and the sheet is stopped.

### SUMMARY OF THE INVENTION

FIG. 6 illustrates a state in which no trouble occurs in films F1 and F2 fed from film rolls 410 and 420. The film rolls 410 and 420 are stored in a film cartridge 400 included in a laminating device.

When a trouble such as a sheet jam or wrinkles of the films F1 and F2 occurs in the laminating device or an apparatus connected to the laminating device, a lamination processor stops at an unexpected time. In this case, as illustrated in FIG. 7, the film F1 fed from the film roll 410 and the film F2 fed from the film roll 420 may become unusable.

When the films F1 and F2 become unusable, a user needs to perform a troubleshooting process. Specifically, the user removes the film cartridge 400 from the laminating device. Next, as illustrated in FIG. 8, the user manually pulls out portions of the film F1 and F2 where the trouble has occurred to the outside of the film cartridge 400 and cuts the portions where the trouble has occurred. Thereafter, the user remounts the film cartridge 400 on the laminating device.

The lengths of the films F1 and F2 manually pulled out by the user in the troubleshooting process cannot be detected by the laminating device. That is, the lengths of the films F1 and F2 consumed to eliminate the trouble cannot be detected by the laminating device.

Therefore, in the conventional invention, the remaining amount of the film, for which the near-empty state is monitored, includes a margin for the film length to be consumed in the troubleshooting process, according to the frequency of occurrence of troubles. However, when no trouble occurs, the margin for the film length to be consumed in the troubleshooting process becomes unnecessary, and the unused film may be unnecessarily discarded. Since the film is expensive as a consumable material, discarding the film unnecessarily leads to increased costs.

An object of the present disclosure is to provide a laminating system and a recording medium capable of reducing waste of a laminate film and suppressing costs without causing damage to an apparatus/device and a product.

To achieve at least one of the abovementioned objects, a laminating system reflecting one aspect of the present invention comprises: a lamination processor that performs a lamination process on a sheet by using a laminate film; and a hardware processor that: calculates a remaining amount of the laminate film based on a feed amount of the laminate film; and, when the remaining amount of the laminate film is equal to or less than a predetermined threshold value, determines that the laminate film is in a near-empty state and stops the lamination processor, wherein in response to a trouble occurring in the laminating system, the hardware processor updates the remaining amount of the laminate film by subtracting a predetermined amount from the remaining amount of the laminate film.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a front view of a schematic configuration of a laminating system according to an embodiment of the present disclosure;

FIG. 2 is a functional block diagram illustrating a control structure of the laminating system according to the embodiment of the present disclosure;

FIG. 3 is a flowchart illustrating a flow of a lamination control process;

FIG. 4 is a diagram illustrating an example of a trouble consumption length selection screen;

FIG. 5 is a diagram illustrating an example of a trouble consumption length input screen;

FIG. 6 is a diagram illustrating a state where no trouble occurs in laminate films;

FIG. 7 is a diagram illustrating a state where a trouble occurs in the laminate films; and

FIG. 8 is a diagram illustrating a state where the laminate films are manually pulled out.

### DETAILED DESCRIPTION

Hereinafter, one or more embodiments of the present invention will be described with reference to the drawings. However, the scope of the invention is not limited to the disclosed embodiments.

### Configuration of Laminating System

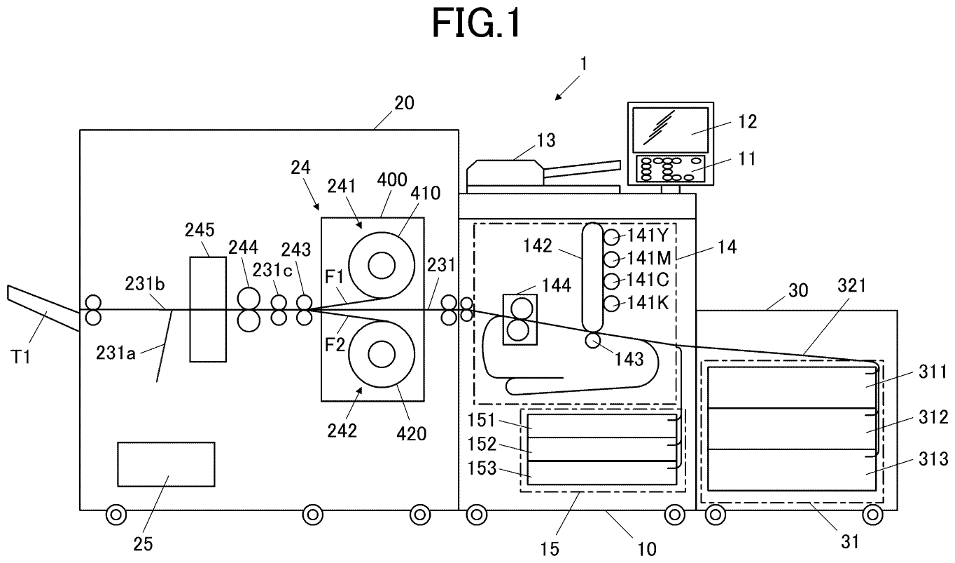

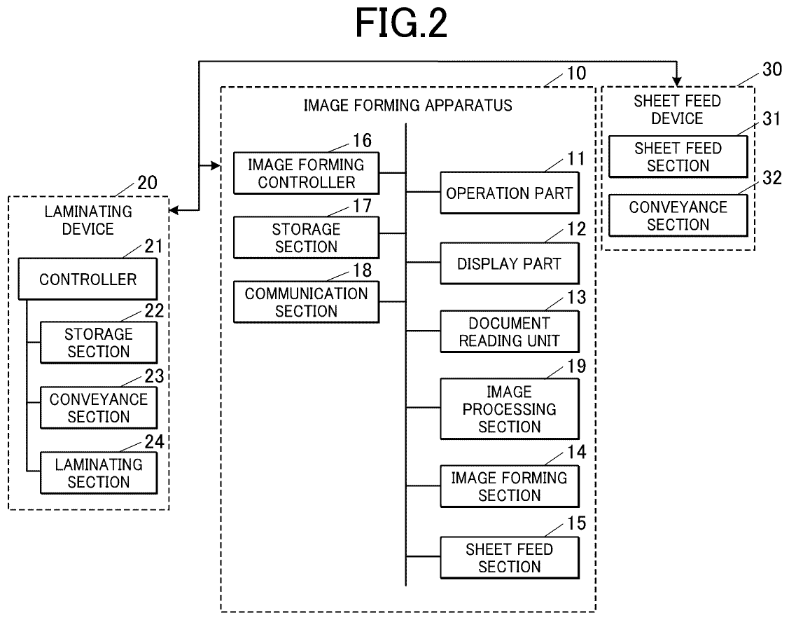

As illustrated in FIGS. 1 and 2, a laminating system (hereinafter, system 1) according to the present embodiment includes a sheet feed device 30, an image forming apparatus 10, and a laminating device 20.

### Configuration of Sheet Feed Device

The sheet feed device 30 includes a sheet feed section 31 and a conveyance section 32. The sheet feed device 30 conveys a sheet from one of sheet feed trays 311 to 313 of the sheet feed section 31 to the image forming apparatus 10 according to a job.

The conveyance section 32 includes a conveyance route 321 that connects the sheet feed section 31 to the image forming apparatus 10. The conveyance section 32 conveys the sheet.

The sheet feed section 31 includes the sheet feed trays 311 to 313 that store sheets of predetermined sheet types and/or sizes.

Depending on the amount of printing in the system 1, the sheet type to be used, and the like, the sheet feed device 30 may not be provided in the system 1, and the sheet may be conveyed only from a sheet feed section 15 (described later) of the image forming apparatus 10.

### Configuration of Image Forming Apparatus

The image forming apparatus 10 forms a color image by an electrophotographic method based on image data obtained by reading an image from a document or image data of a job received from an external device (not illustrated). The image forming apparatus 10 ejects the sheet after image formation to the laminating device 20.

As illustrated in FIGS. 1 and 2, the image forming apparatus 10 includes an operation part 11, a display part 12, a document reading unit 13, an image forming section (image former) 14, a sheet feed section 15, an image forming controller 16, a storage section 17, a communication section 18, and an image processing section 19.

The operation part 11 includes a touch screen formed to cover a display screen of the display part 12, and various operation buttons such as numeric buttons and a start button. The operation part 11 outputs an operation signal based on a user operation to the image forming controller 16.

The display part 12 includes a liquid crystal display (LCD) and displays various screens in accordance with instructions of display signals input from the image forming controller 16.

The document reading unit 13 includes an automatic document feeder (ADF), which is an automatic document sheet feed device, a scanner, and the like. The document reading unit 13 outputs image data obtained by reading an image of a document to the image forming controller 16.

The image forming section 14 forms an image on the sheet fed from the sheet feed section 15 or the sheet feed device 30 based on the image data on which image processing has been performed by the image processing section 19. In the present embodiment, the sheet is a flat cut sheet.

The image forming section 14 includes photosensitive drums 141Y, 141M, 141C, and 141K corresponding to the colors of yellow (Y), magenta (M), cyan (C), and black (K), an intermediate transfer belt 142, a secondary transfer roller 143, a fixing section 144, and the like.

The image forming section 14 uniformly charges the photosensitive drum 141Y and then scans and exposes the photosensitive drum 141Y with a laser beam based on the image data for the yellow color, thereby forming an electrostatic latent image on the photosensitive drum 141Y. Next, the image forming section 14 causes a developing section (not illustrated) to attach a yellow toner to the electrostatic latent image on the photosensitive drum 141Y to develop the electrostatic latent image.

The photosensitive drums 141M, 141C, and 141K are the same as the photosensitive drum 141Y except that the colors to be handled are different, and thus a description thereof is omitted.

The image forming section 14 sequentially transfers the toner images of the respective colors formed on the photosensitive drums 141Y, 141M, 141C, and 141K onto the rotating intermediate transfer belt 142 (primary transfer). That is, the image forming section 14 forms a color toner image in which the toner images in four colors are superimposed on the intermediate transfer belt 142. The image forming section 14 includes a cleaning blade (not illustrated) that removes residual toner on the photosensitive drums 141Y, 141M, 141C, and 141K after the primary transfer.

The image forming section 14 collectively transfers the color toner image on the intermediate transfer belt 142 onto the sheet by the secondary transfer roller 143 (secondary transfer).

The fixing section 144 includes a heating roller that heats the sheet onto which the toner image has been transferred and a pressure roller that presses the sheet. The fixing section 144 fixes the color toner image onto the sheet by heating and pressing.

The sheet feed section 15 includes sheet feed trays 151 to 153 and feeds the sheet to the image forming section 14. The sheet feed trays 151 to 153 store sheets of predetermined sheet types and/or sizes.

The image forming controller 16 includes a central processing unit (CPU), a random-access memory (RAM), a read only memory (ROM), and the like. The CPU of the image forming controller 16 reads various processing programs stored in the ROM, deploys the programs in the RAM, and comprehensively controls the operation of the image forming apparatus 10 in accordance with the various programs deployed in the RAM.

When a lamination process is to be performed on the sheet ejected from the image forming apparatus 10, the image forming controller 16 instructs the laminating device 20 to perform a predetermined lamination process.

The storage section 17 is a nonvolatile storage device such as a hard disk drive (HDD) or a semiconductor memory that stores various data such as a program and image data. The storage section 17 stores data such as program data and various setting data so that the data can be read and written by the image forming controller 16.

The storage section 17 stores, for each of the sheet feed trays, information on the sheet type, size, and the like of the sheets stored in the sheet feed trays 311 to 313 of the sheet feed device 30 and the sheet feed trays 151 to 153 of the sheet feed section 15.

The communication section 18 includes a communication control card such as a local area network (LAN) card. The communication section 18 transmits and receives various data to and from an external device (e.g., a personal computer) connected to a communication network such as a LAN or a wide area network (WAN).

The image processing section 19 performs necessary image processing on the image data stored in the storage section 17, the image data obtained by reading the image from the document by the document reading unit 13, and image data input from the external device. The image processing section 19 transmits the image data after the image processing to the image forming section 14. The image processing includes gradation processing, halftone processing, color conversion processing, and the like. The gradation processing is processing for converting the gradation value of each pixel of the image data into a corrected gradation value corrected such that the density characteristics of the image formed on the sheet match the target density characteristics. The halftone processing includes error diffusion processing, screen processing using a systematic dither method, and the like. The color conversion processing is processing for converting each gradation value of RGB into each gradation value of CMYK.

### Configuration of Laminating Device

The laminating device 20 is disposed downstream of the image forming apparatus 10 in a sheet conveyance direction and performs the lamination process on the sheet after the image formation conveyed from the image forming apparatus 10.

The laminating device 20 includes a controller (hardware processor) 21, a storage section 22, a conveyance section 23, a laminating section 24, which is a lamination processor, a waste box 25, a sheet ejection tray T1, and the like. The waste box 25 is disposed downstream of the laminating section 24 in the sheet conveyance direction and stores cutting waste generated when a film is cut by a cutting part 245 to be described later. The sheet ejection tray T1 loads the sheet ejected from the laminating device 20.

The controller 21 includes a CPU, a RAM, a ROM, and the like. The CPU of the controller 21 reads various processing programs stored in the ROM, deploys the programs in the RAM, and comprehensively controls the operation of the laminating device 20 in cooperation with the various programs deployed in the RAM.

In response to an instruction signal received from the image forming apparatus 10, the controller 21 causes the laminating section 24 to perform the lamination process on the sheet.

The storage section 22 is a nonvolatile storage device such as an HDD or a semiconductor memory that stores various data such as a program. The storage section 22 stores data such as program data and various setting data so that the data can be read and written by the controller 21.

The conveyance section 23 includes a conveyance route 231 and a plurality of rollers. The plurality of rollers includes conveyance rollers 231c disposed between a bonding part 243 (described later) and a pressure bonding part 244 (described later) on the conveyance route 231.

The conveyance section 23 conveys the sheet conveyed from the image forming apparatus 10 to the laminating section 24. Next, the conveyance section 23 conveys the sheet laminated by the laminating section 24 through a conveyance route 231b and ejects the sheet to the outside of the device (sheet ejection tray T1).

The conveyance section 23 conveys cutting waste generated when a film is cut by the cutting part 245 to the waste box 25 through a conveyance route 231a.

The conveyance section 23 may include a conveyance route through which the sheet conveyed from the image forming apparatus 10 is ejected to the sheet ejection tray T1 without passing through the laminating section 24.

The laminating section 24 includes a first film supply part 241, a second film supply part 242, the bonding part 243, the pressure bonding part 244, and the cutting part 245.

The first film supply part 241 supplies a film F1 from a film roll 410. The film roll 410 is a roll of the film F1 including a transparent synthetic resin film layer and an adhesive layer. An adhesive is applied to one side (the side to be in contact with the sheet) of the film F1 to form the adhesive layer.

The film F1 is conveyed from the first film supply part 241 to a nip portion of the bonding part 243 to be bonded to the image surface of the sheet.

The second film supply part 242 supplies a film F2 from a film roll 420. The film roll 420 is a roll of the film F2 including a transparent synthetic resin film layer. That is, an adhesive layer is not formed in the film F2.

The film F2 is conveyed from the second film supply part 242 to the nip portion of the bonding part 243. Here, the film F2 is placed on the non-image side of the sheet.

The film F2 may include an adhesive layer.

The film rolls 410 and 420 are stored in a film cartridge 400.

The bonding part 243 includes a pair of rollers. The bonding part 243 sandwiches the sheet and the films F1 and F2 at the nip portion formed by the pair of rollers to bond the adhesive layer of the film F1 to the surface of the sheet. As a result, the sheet and the film F1 are bonded to each other. Then, until the next sheet is conveyed, the bonding part 243 sandwiches the film F1 and the film F2 at the nip portion formed by the pair of rollers to bond the film F2 to the adhesive layer of the film F1. As a result, the film F1 and the film F2 are bonded to each other. This prevents, on the conveyance route after the bonding part 243, the adhesive applied to the film F1 from contacting the conveyance route.

The pressure bonding part 244 includes a pair of rollers. The pressure bonding part 244 sandwiches and presses the sheet and the films F1 and F2 at a nip portion formed by the pair of rollers to pressure-bond the adhesive layer of the film F1 to the sheet or the film F2.

The cutting part 245 is disposed downstream of the pressure bonding part 244 in the conveyance route 231 and cuts the film F1 and the film F2 at the leading edge and the trailing edge of the conveyed sheet.

### Operation of Laminating System

Next, the operation of the system 1 according to the present embodiment will be described.

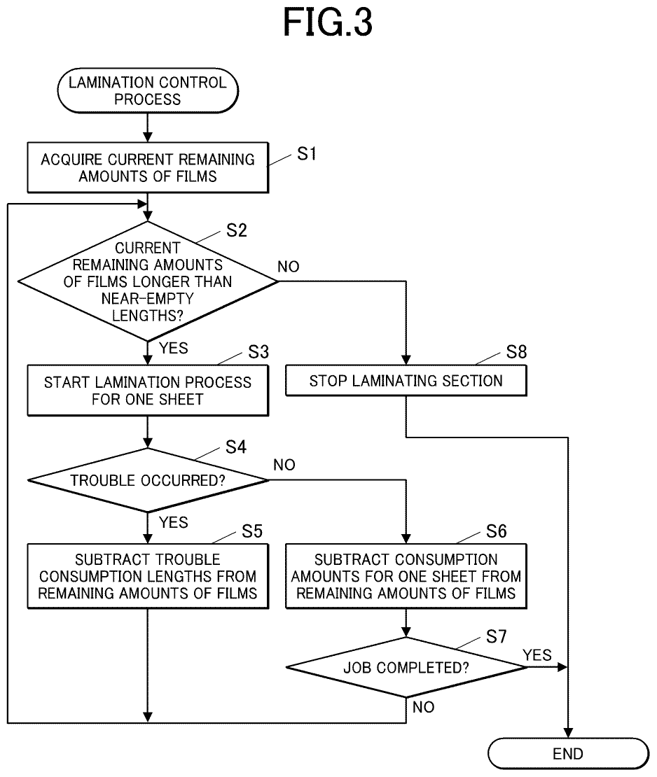

The system 1 executes a lamination control process illustrated in FIG. 3 in the following case.

Specifically, it is a case where the image forming apparatus 10 receives a job including the lamination process from the external device or a case where a job including the lamination process is input by a user via the operation part 11.

The job includes setting information for the job.

The setting information for the job includes the size of a sheet to be subjected to the lamination process (target sheet), the types of the films F1 and F2, lamination processing conditions that are processing conditions in the lamination process, and the like.

The lamination processing conditions include information as to whether the films F1 and F2 are to be consumed by a predetermined amount longer than the length of the sheet in the conveyance direction, the films F1 and F2 are to be consumed by the same length as the length of the sheet in the conveyance direction, or the films F1 and F2 are to be consumed by a predetermined amount shorter than the length of the sheets in the conveyance direction. When the films F1 and F2 are consumed by a predetermined amount longer than the length of the sheet in the conveyance direction, or when the films F1 and F2 are consumed by a predetermined amount shorter than the length of the sheet in the conveyance direction, the lamination processing conditions include information on the predetermined amount.

### Lamination Control Process

The controller 21 of the laminating device 20 acquires the current remaining amount of the films F1 and F2 mounted on the laminating section 24 (step S1). Specifically, the controller 21 calculates the feed amount of the film F1 at the present time after the film roll 410 is mounted on the first film supply part 241 based on the drive time or the drive amount of the conveyance mechanism for conveying the film F1. Next, the controller 21 calculates the current remaining amount of the film F1 by subtracting the current feed amount of the film F1 from the length of the film F1 at the time when the film roll 410 is mounted on the first film supply part 241. Similarly, the controller 21 calculates the current remaining amount of the film F2.

That is, the controller 21 calculates the remaining amounts of the films F1 and F2 based on the feed amounts of the films F1 and F2 (laminate films). The controller 21 functions as a calculation section.

Next, the controller 21 determines whether the current remaining amounts of the respective films F1 and F2 acquired in step S1 are longer than near-empty lengths (step S2).

The near-empty lengths according to the present embodiment are the remaining amounts of the respective films F1 and F2 at the time when the controller 21 detects near-empty states for the respective films F1 and F2. The near-empty lengths include, for example, unusable lengths of the respective films F1 and F2. The unusable lengths of the respective films F1 and F2 are conveyance distances of the respective films F1 and F2 from the roll cores of the respective film rolls 410 and 420 to the bonding part 243.

The near-empty lengths according to the present embodiment do not include margins for the lengths of the respective films F1 and F2 to be consumed to eliminate a trouble that has occurred in the system 1 in a troubleshooting process by the user.

Hereinafter, in the troubleshooting process by the user, the lengths of the respective films F1 and F2 to be consumed to eliminate a trouble that has occurred in the system 1 are also referred to as “trouble consumption lengths”.

When the current remaining amounts of the respective films F1 and F2 are longer than the near-empty lengths (step S2; YES), the controller 21 causes the laminating section 24 to start the lamination process for one target sheet based on the lamination processing conditions (step S3).

Next, the controller 21 determines whether a trouble has occurred in the system 1 (step S4). The trouble includes a sheet jam, a lamination failure such as a wrinkle of the films F1 or a wrinkle of the film F2, and the like.

When a trouble occurs in the system 1, the user removes the film cartridge 400 from the laminating device 20 as part of the troubleshooting process. Next, the user manually pulls out the films F1 and F2 from the film cartridge 400 and cuts portions where the trouble has occurred. Thereafter, the user remounts the film cartridge 400 on the laminating device 20.

When a trouble has occurred in the system 1 (step S4; YES), the controller 21 subtracts the trouble consumption lengths of the respective films F1 and F2 from the remaining amounts of the respective films F1 and F2 acquired in step S1 and updates the current remaining amounts of the respective films F1 and F2 (step S5). Next, the controller 21 advances the lamination control process to step S2.

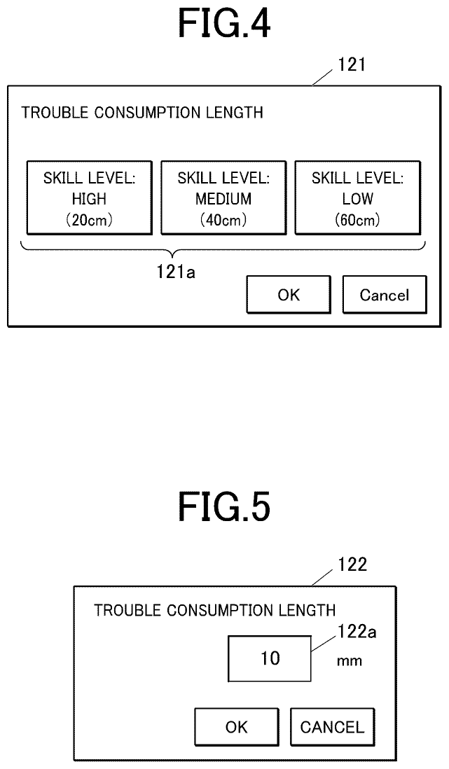

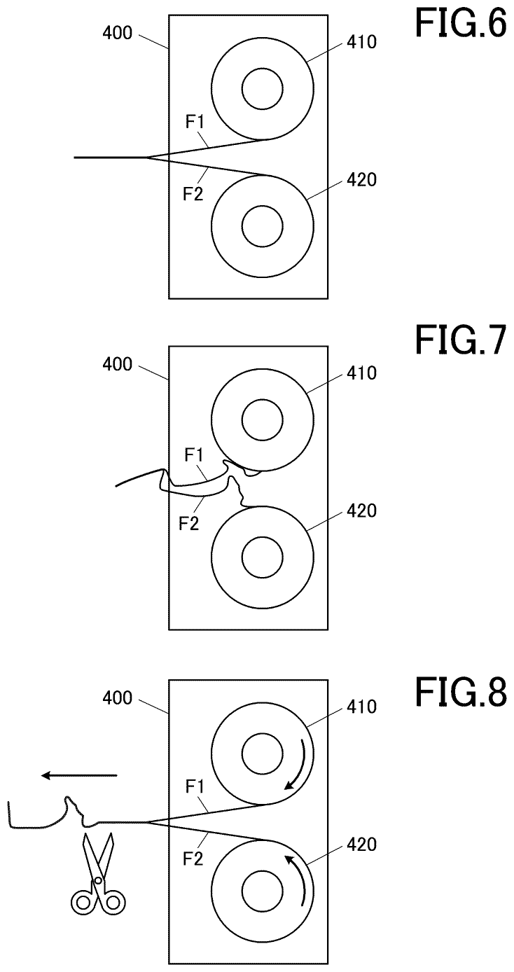

In step S5, the controller 21 transmits to the image forming apparatus 10 an instruction signal for causing the display part 12 to display, for example, a trouble consumption length selection screen 121 (see FIG. 4). Next, the controller 21 receives from the image forming apparatus 10 an operation signal by the user via the operation part 11 for selecting the trouble consumption lengths of the respective films F1 and F2, which is received on the trouble consumption length selection screen 121.

The films F1 and F2 are thin and prone to damage such as wrinkles. In addition, since the adhesive is applied to the film F1, it is difficult for the user to manually pull out the film F1 by an appropriate length in the troubleshooting process. Therefore, the trouble consumption lengths of the respective films F1 and F2 vary depending on the user's skill level.

In the example illustrated in FIG. 4, the controller 21 displays, on the trouble consumption length selection screen 121, a selection button 121a for selecting the trouble consumption length “20 cm” when the user's skill level is “high”, the trouble consumption length “40 cm” when the user's skill level is “medium”, or the trouble consumption length “60 cm” when the user's skill level is “low”.

The trouble consumption length “20 cm” when the skill level is “high” is, for example, the conveyance distances of the respective films F1 and F2 from the positions where the films F1 and F2 are separated from the respective film rolls 410 and 420 to the bonding part 243.

In step S5, the controller 21 may transmit to the image forming apparatus 10 an instruction signal for causing the display part 12 to display a trouble consumption length input screen 122 (see FIG. 5). In this case, the controller 21 receives from the image forming apparatus 10 an operation signal by the user via the operation part 11 for inputting the trouble consumption lengths of the respective films F1 and F2, which is received in an input field 122a of the trouble consumption length input screen 122.

The properties of the films F1 and F2, such as rigidity and adhesiveness, differ depending on the types of the films F1 and F2. Therefore, when the user manually pulls out the films F1 and F2 in the troubleshooting process, the difficulty level of pulling out an appropriate length varies depending on the types of the films F1 and F2.

Therefore, in step S5, the controller 21 may calculate the trouble consumption lengths of the respective films F1 and F2 for the respective types of the films F1 and F2. For example, the controller 21 calculates the trouble consumption lengths of the respective films F1 and F2 by associating the pre-measured types of the respective films F1 and F2 with coefficients related to the trouble consumption lengths of the respective films F1 and F2.

Specifically, when the films F1 and F2 are thicker than the standard film, the controller 21 sets the trouble consumption lengths of the films F1 and F2 to be smaller than that of a film having the standard thickness.

When the films F1 and F2 are matte-type films having no gloss, the controller 21 sets the trouble consumption lengths of the films F1 and F2 to be smaller than that of a glossy film having a strong gloss.

When the surfaces of the films F1 and F2 are embossed or hologram-processed, the controller 21 sets the trouble consumption lengths of the films F1 and F2 to be smaller than that of a film whose surface is not embossed or hologram-processed.

In step S5, the controller 21 may calculate the trouble consumption lengths of the films F1 and F2 according to the type of trouble occurring in the system 1.

The type of trouble occurring in the system 1 includes, for example, a sheet jam when there is no sheet in the laminating section 24, a sheet jam when there is a sheet in the laminating section 24, a lamination failure, and the like. The lamination failure includes misalignment between the films F1 and F2, the presence of wrinkles in the films F1 and F2, and the like.

In the case where a sheet jam occurs when there is no sheet in the laminating section 24, the troubleshooting process in the laminating section 24 is unnecessary. Therefore, the trouble consumption lengths of the films F1 and F2 in this case are 0.

On the other hand, in the case where a sheet jam occurs when there is a sheet in the laminating section 24, the troubleshooting process in the laminating section 24 is necessary. Therefore, the trouble consumption lengths of the respective films F1 and F2 in this case are at least the conveyance distances of the respective films F1 and F2 from the positions where the films F1 and F2 are separated from the respective film rolls 410 and 420 to the bonding part 243.

When a lamination failure occurs, in the troubleshooting process, the user peels off the bond between the film F1 and the film F2 and rejoins the film F1 and the film F2 with the misalignment between the films corrected. Therefore, the trouble consumption lengths of the respective films F1 and F2 in this case are at least the conveyance distances of the respective films F1 and F2 from the bonding part 243 to the conveyance rollers 23 1c.

In step S5, while there is no sheet jam occurring in the system 1, when the film cartridge 400 is removed from the laminating device 20 and then the same film cartridge 400 is remounted on the laminating device 20, the controller 21 determines that a lamination failure has occurred in the system 1. The controller 21 determines whether the film cartridge 400 removed from and remounted on the laminating device 20 is the same film cartridge 400 based on an identifier that the film cartridge 400 has.

On the other hand, when no trouble occurs in the system 1 (step S4; NO), the controller 21 calculates the lengths of the films F1 and F2 consumed in the lamination process in step S3 based on the size of the target sheet, the lamination processing conditions, and the like.

For example, a case will be described in which the length of the target sheet in the conveyance direction is 210 mm, and the lamination processing conditions include that, at the front and rear ends of the sheet in the conveyance direction, the films F1 and F2 are consumed 5 mm longer than the end portions of the sheet in the conveyance direction. In this case, the controller 21 calculates the consumption lengths of the films F1 and F2 for the one target sheet in the lamination process in step S3 as 5+210+5=220 mm.

Alternatively, the controller 21 may calculate the consumption lengths of the films F1 and F2 for one target sheet in the lamination process in step S3 based on the feed amounts of the films F1 and F2.

Next, the controller 21 subtracts the lengths of the films F1 and F2 consumed in the lamination process in step S3 from the remaining amounts of the films F1 and F2 acquired in step S1 and updates the current remaining amounts of the films F1 and F2 (step S6).

Next, the controller 21 determines whether the job has been completed (step S7).

If the job has been completed (step S7; YES), the controller 21 ends the lamination control process.

On the other hand, if the job has not been completed (step S7; NO), the controller 21 advances the lamination control process to step S2.

When the current remaining amount of the film F1 or F2 is equal to or less than the near-empty length (NO in step S2), that is, when the controller 21 detects the near-empty state, the controller 21 stops the lamination process for the job (step S8) and ends the lamination control process.

That is, when the current remaining amount of the film F1 or F2 (laminate film) is equal to or less than the near-empty length (predetermined threshold value), the controller 21 determines that the laminate film is in the near-empty state and stops the laminating section 24 (lamination processor).

### Effects

As described above, the laminating system (system 1) according to the present embodiment includes the lamination processor (laminating section 24) that performs the lamination process on a sheet by using the laminate film (films F1 and F2).

The laminating system according to the present embodiment includes a calculation section (controller 21) that calculates the remaining amount of the lamination film based on the feed amount of the laminate film.

The laminating system according to the present embodiment includes the controller 21 that, when the remaining amount of the laminate film is equal to or less than a predetermined threshold value, determines that the laminate film is in the near-empty state and stops the lamination processor.

In response to a trouble occurring in the laminating system, the calculation section updates the remaining amount of the laminate film by subtracting a predetermined amount (trouble consumption length) from the remaining amount of the laminate film.

Therefore, it is not necessary to include, in the near-empty length, a margin for the film length to be consumed in the troubleshooting process. Therefore, when no trouble occurs in the system 1, eliminating the need for this margin prevents the film from being unnecessarily discarded.

This makes it possible to reduce waste of the laminate film and suppress costs without causing damage to an apparatus/device and a product.

In the laminating system (system 1) according to the present embodiment, the calculation section (controller 21) subtracts the predetermined amount from the remaining amount of the laminate film (films F1 and F2) each time a trouble occurs.

Therefore, it is not necessary to include, in the near-empty length, a margin for the film length to be consumed in the troubleshooting process. Therefore, when no trouble occurs in the system 1, eliminating the need for this margin prevents the film from being unnecessarily discarded.

In the laminating system according to the present embodiment (system 1), the predetermined amount (trouble consumption length) is variable.

Therefore, the trouble consumption length can be set according to various situations.

In the laminating system (system 1) according to the present embodiment, the calculation section (controller 21) calculates the predetermined amount (trouble consumption length) based on the type of the laminate film (films F1 and F2).

Therefore, the trouble consumption length can be set to an appropriate length corresponding to the type of the laminate film.

In the laminating system (system 1) according to the present embodiment, the calculation section (controller 21) calculates the predetermined amount (trouble consumption length) based on the type of trouble occurring in the laminating system.

Therefore, the trouble consumption length can be set to an appropriate length corresponding to the type of trouble.

In the laminating system (system 1) according to the present embodiment, the calculation section (controller 21) determines that the type of trouble is a lamination failure when the cartridge (film cartridge 400) storing the laminate film (films F1 and F2) is removed from the laminating system and then the same cartridge is remounted on the laminating system.

Therefore, even when the laminating system does not include a reading device that reads a laminated sheet, it is possible to easily determine that a lamination failure has occurred.

A laminating system (system 1) according to the present embodiment includes the image forming section 14 that forms an image on a sheet.

The lamination processor (laminating section 24) performs the lamination process on the sheet on which the image has been formed by the image forming section 14.

Thus, even in a configuration in which the image forming apparatus 10 is disposed upstream of the laminating device 20, it is possible to reduce the waste of the laminate film and suppress the costs without causing damage to an apparatus/device and a product.

Although specific description has been given above based on the embodiment according to the present disclosure, the present disclosure is not limited to the above-described embodiment, and changes can be made without departing from the spirit and scope of the present disclosure.

For example, the lamination method of the above-described embodiment is a cold lamination method in which the laminate film is fixed by the adhesive layer that can be bonded at room temperature without heating the laminate film, but the present invention is not limited thereto. The lamination method may be a hot lamination method in which an adhesive layer of the laminate film is melted and fixed by a fixing section.

In the laminating section 24 of the above-described embodiment, the laminate films are bonded to both sides of the sheet, but the present invention is not limited thereto. In the laminating section 24, the laminate film may be bonded to one side of the sheet.

Besides, the detailed configuration of each component constituting the laminating system and the detailed operation of each component can also be appropriately modified without departing from the spirit and scope of the present disclosure.

Although embodiments of the present invention have been described and illustrated in detail, the disclosed embodiments are made for purposes of illustration and example only and not limitation. The scope of the present invention should be interpreted by terms of the appended claims.

What is claimed is:

1. A laminating system comprising:
a lamination processor that performs a lamination process on a sheet by using a laminate film; and
a hardware processor that:
calculates a remaining amount of the laminate film based on a feed amount of the laminate film; and,
when the remaining amount of the laminate film is equal to or less than a predetermined threshold value, determines that the laminate film is in a near-empty state and stops the lamination processor, wherein
in response to a trouble occurring in the laminating system, the hardware processor updates the remaining amount of the laminate film by subtracting a predetermined amount from the remaining amount of the laminate film.

2. The laminating system according to claim 1, wherein the hardware processor subtracts the predetermined amount from the remaining amount of the laminate film each time the trouble occurs.

3. The laminating system according to claim 2, wherein the predetermined amount is variable.

4. The laminating system according to claim 3, wherein the hardware processor calculates the predetermined amount based on a type of the laminate film.

5. The laminating system according to claim 3, wherein the hardware processor calculates the predetermined amount based on a type of the trouble.

6. The laminating system according to claim 5, wherein the hardware processor determines the type of the trouble as a lamination failure when a cartridge storing the laminate film is removed from the laminating system and then the same cartridge is remounted on the laminating system.

7. The laminating system according to claim 1, further comprising an image former that forms an image on the sheet, wherein the lamination processor performs the lamination process on the sheet on which the image has been formed by the image former.

8. A non-transitory computer-readable recording medium storing a computer-executable program, the program causing a computer of a laminating system including a lamination processor that performs a lamination process on a sheet by using a laminate film to:
calculate a remaining amount of the laminate film based on a feed amount of the laminate film; and,
when the remaining amount of the laminate film is equal to or less than a predetermined threshold value, determine that the laminate film is in a near-empty state and stop the lamination processor, wherein
in response to a trouble occurring in the laminating system, the program further causes the computer to update the remaining amount of the laminate film by subtracting a predetermined amount from the remaining amount of the laminate film.
